(19) United States
(12) Patent Application Publication
(10) Pub. No.: US 2017/0310036 A1
(43) Pub. Date: Oct. 26, 2017

(54) POWER-SOURCE CONNECTOR INCLUDING TERMINAL-CONTACT PREVENTION MECHANISM AND POWER-SOURCE CONNECTOR DEVICE INCLUDING THE SAME

(71) Applicant: HIROSE ELECTRIC CO., LTD., Tokyo (JP)

(72) Inventor: Shozo Ono, Tokyo (JP)

(21) Appl. No.: 15/492,134

(22) Filed: Apr. 20, 2017

(30) Foreign Application Priority Data
Apr. 26, 2016 (JP) 2016-87862

(51) Int. Cl. H01R 13/424; H01R 13/627; H01R 13/506

(52) U.S. Cl. CPC H01R 13/424; H01R 13/506; H01R 13/627

(57) ABSTRACT

A power-source connector includes a power-source terminal and a housing that supports the power-source terminal. The housing includes at least two adjoining insertion ports, each partitioned by a partitioning member and through any of which an electrically conductive member is inserted, and a housing space, connected to the insertion ports. The power-source terminal includes a contact portion, disposed in the housing space and being contactable with the electrically conductive member inserted through any of the at least two adjoining insertion ports. The contact portion is disposed so as to extend across the at least two adjoining insertion ports.

### BACKGROUND OF THE INVENTION

### 1. Field of the Invention

The present invention relates to a power-source connector including a mechanism, for example, for preventing fingers from touching terminals and to a power-source connector device including the same.

### 2. Description of the Related Art

Japanese Unexamined Patent Application Publication No. 2014-179290 discloses an example of a power-source connector including a mechanism for preventing terminals from being touched. A front surface of the power-source connector has an opening connected to a receiving portion that receives a terminal. A counterpart terminal of a counterpart power-source connector is inserted into the receiving portion through the opening and connected to the terminal disposed in the receiving portion. In the connector disclosed in Japanese Unexamined Patent Application Publication No. 2014-179290, an insulating member is fixed to a tip end of the terminal to prevent a finger inserted by mistake into the receiving portion through the opening, particularly, the open end at the end of the opening from touching the terminal received by the receiving portion and causing an accident such as an electric-shock accident.

The configuration according to Japanese Unexamined Patent Application Publication No. 2014-179290 can prevent an accident such as an electric-shock accident, since a finger touches the insulating member before touching the terminals. However, as the electrical current value increases, the terminals are enlarged and, accordingly, the open end is enlarged. Thus, the terminals are rendered more easily touchable by a finger or the like. In the case where insulating members are individually provided to the terminals, the size of each insulating member has to be adjusted in accordance with the size of the corresponding terminal. Moreover, in the case where terminals are required to be individually provided to open ends, insulating members are also required to be individually provided to the open ends. This configuration renders the operation very complicated and increases production costs.

The present invention was made to solve the above-described problems that occur in existing technologies. An object of the invention is to provide a power-source connector and a power-source connector device including the power-source connector, the power-source connector including a terminal that is less easily touchable by a finger or the like even if the terminal has a large size, the power-source connector dispensing with the need for disposing the insulating members corresponding to individual open ends.

### SUMMARY OF THE INVENTION

To solve the above-described problems, a power-source connector according to an aspect of the invention includes a power-source terminal and a housing that supports the power-source terminal. The housing includes at least two adjoining insertion ports, each partitioned by a first partitioning member and through any of which an electrically conductive member is inserted, and a housing space, which is connected with the insertion ports. The power-source terminal includes a contact portion, disposed in the housing space and being contactable with the electrically conductive member inserted through any of the at least two adjoining insertion ports. The contact portion is disposed so as to extend across the at least two adjoining insertion ports.

The power-source connector according to this aspect can provide a power-source connector and a power-source connector device including the power-source connector, the power-source connector including a terminal that is less easily touchable by a finger even if the terminal has a large size, the power-source connector dispensing with the need for disposing insulating members corresponding to individual open ends.

Preferably, in the power-source connector according to the above-described aspect, the first partitioning member extends in the housing space in a direction in which the electrically conductive member is inserted thereinto through any of the insertion ports.

In the power-source connector according to this aspect, the first partitioning member extends in the housing space in a direction in which the electrically conductive member is inserted thereinto. Thus, the electrically conductive member can be more stably inserted into and removed from the housing space.

Preferably, the power-source connector according to the above-described aspect also includes a second partitioning member that partitions each of the at least two adjoining insertion ports in a direction crossing the first partitioning member.

In the power-source connector according to this aspect, the second partitioning member renders the insertion port much smaller, so that an accident in which fingers touch the contact portion can be more effectively prevented.

Preferably, in the power-source connector according to the above-described aspect, the first partitioning member and the second partitioning member are constituted by using the housing.

In the power-source connector according to this aspect, the first partitioning member and the second partitioning member are formed from the housing. Thus, the partitioning members can be produced by, for example, integral molding at lower cost.

Preferably, in the power-source connector according to the above-described aspect, the second partitioning member extends, together with the first partitioning member, in the housing space in an insertion direction in which the electrically conductive member is inserted thereinto through any of the insertion ports. Preferably, the first partitioning member and the second partitioning member define multiple housing units, housing multiple pieces of the electrically conductive member.

In the power-source connector according to this aspect, providing the housing unit allows the electrically conductive member to be more stably inserted into and removed from the housing space.

Preferably, in the power-source connector according to the above-described aspect, the multiple pieces of the electrically conductive member are at least partially covered with housed units corresponding to the pieces of the electrically conductive member and are housed in the respective housing units together with the corresponding housed units.

In the power-source connector according to this aspect, the electrically conductive member is reinforced, so that problems such as bucking of the electrically conductive member caused when being housed in the housed units can be reduced.

Preferably, in the power-source connector according to the above-described aspect, the multiple pieces of the electrically conductive member are connected to one another.

In the power-source connector according to this aspect, the multiple pieces of the electrically conductive member, connected to one another, can be integrally handled.

Preferably, in the power-source connector according to the above-described aspect, the contact portion constitutes a portion of the second partitioning member.

In the power-source connector according to this aspect, the contact portion constitutes a portion of the second partitioning member, so that the structure of the power-source connector can be simplified.

Preferably, in the power-source connector according to the above-described aspect, the contact portion is located on a side of the insertion ports opposite to a side from which the electrically conductive member is inserted at a position further from the insertion ports than is a portion of the second partitioning member.

In the power-source connector according to this aspect, the second partitioning member is located on the side of the contact portion from which the electrically conductive member is inserted. This configuration can thus prevent fingers from touching the contact portion.

Preferably, in the power-source connector according to the above-described aspect, the contact portion is held by the housing units.

In the power-source connector according to this aspect, the contact portion is held by the electrically conductive member, so that the contact portion and the electrically conductive member can keep stable contact therebetween.

The power-source connector according to the above-described aspect may constitute a power-source connector device together with another power-source connector that supports the electrically conductive member.

The present invention provides a power-source connector and a power-source connector device including the power-source connector, the power-source connector including a terminal that is less easily touchable by a finger or the like even if the terminal has a large size, the power-source connector dispensing with the need for disposing insulating members corresponding to individual open ends.

### BRIEF DESCRIPTION OF THE DRAWINGS

FIG. 1 is an external perspective view of a power-source connector device according to an embodiment of the invention;

FIG. 2 is a schematic perspective view of only a plug connector;

FIG. 3 is a side view of the plug connector and a socket connector fitted to each other;

FIG. 4 is a sectional view of the plug connector and the socket connector taken along line IV-IV of FIG. 3;

FIG. 5 is an exploded perspective view of the socket connector;

FIG. 6 is a front view of a socket housing;

FIGS. 7A to 7C are sectional views of the socket housing illustrated in FIG. 6;

FIG. 8 is an exploded perspective view of the plug connector;

FIG. 9 is a front view of a plug housing;

FIGS. 10A to 10C are sectional views of the plug housing illustrated in FIG. 9;

FIG. 11 is a perspective view of the plug terminal and the socket terminal connected with each other;

FIG. 12 is a perspective view of a plug connector according to a modified example;

FIG. 13 is a perspective view of a socket connector according to the modified example; and

FIG. 14 is a perspective view of a socket connector according to another modified example.

### DESCRIPTION OF THE PREFERRED EMBODIMENTS

Referring now to the attached drawings, an embodiment of the invention is described below. For convenience of illustration, only one embodiment of the invention is described below, but, naturally, the invention is not limited to this embodiment.

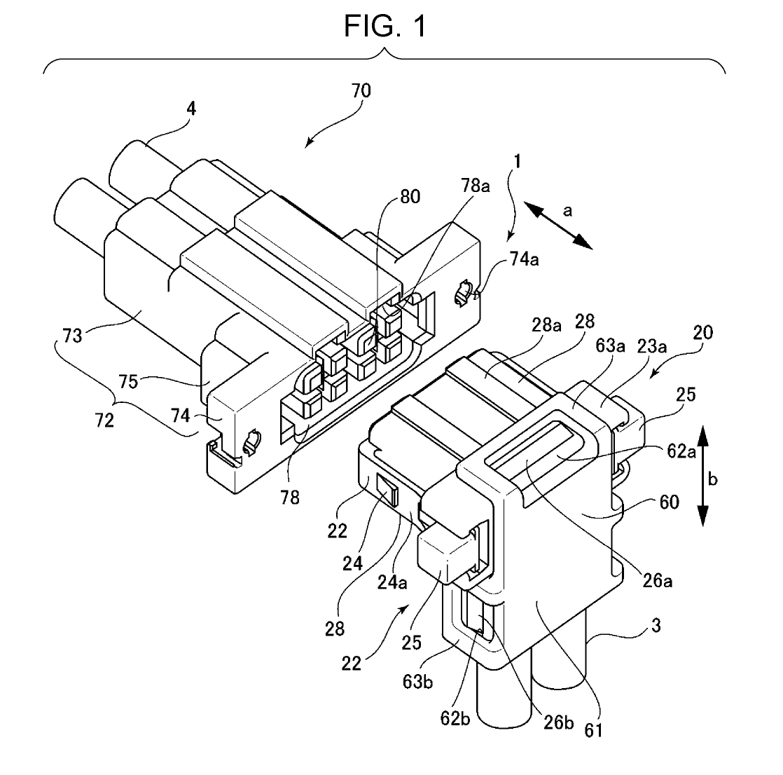

FIG. 1 is an external perspective view of a power-source connector device according to an embodiment of the invention. A power-source connector device 1 includes a pair of power-source connectors 20 and 70. The power-source connector 20 may be, for example, a plug connector. The power-source connector 70 may be, for example, a socket connector. The plug connector 20 and the socket connector 70 each have a symmetrical shape. The plug connector 20 is insertable into and removable from the socket connector 70 in a direction of arrow “a” in FIG. 1.

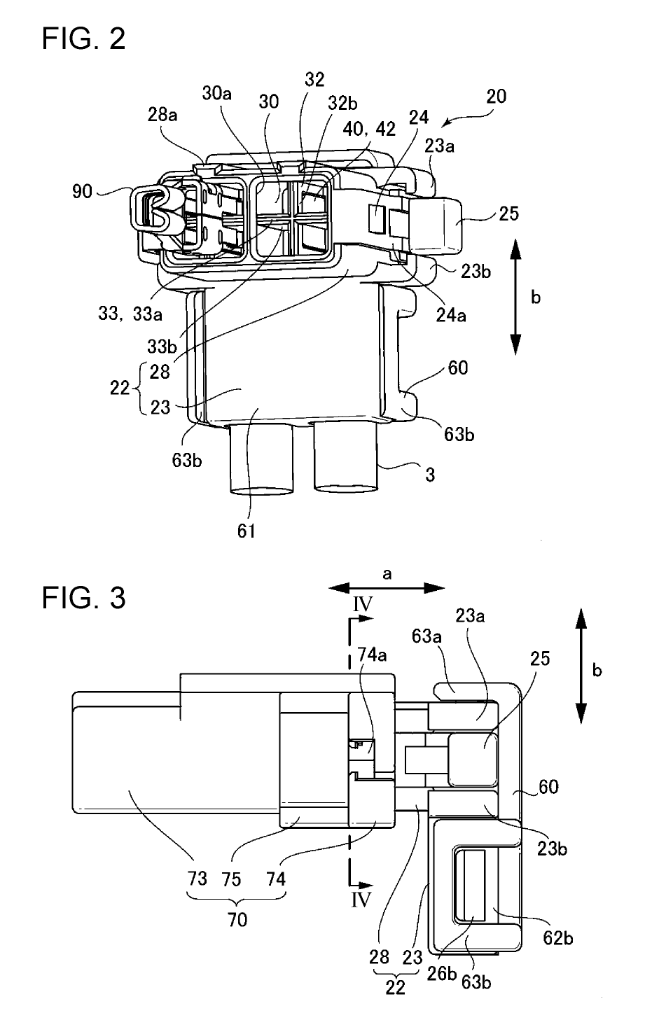

FIG. 2 is a schematic perspective view of the plug connector 20. For convenience' sake, FIG. 2 illustrates the state where socket terminals (electrically conductive members) 90 of the socket connector 70 are inserted into the plug connector 20.

As illustrated in FIGS. 1 and 2, the socket connector 70 includes the socket terminals 90 (see FIG. 2) and an insulating socket housing 72 that supports the socket terminals 90. The socket housing 72 includes a body 73, a wide portion 75, wider than the body 73, and a flange 74, wider than the wide portion 75, which are arranged in an insertion direction “a”. Power source cables 4 extend in the direction “a”, the same as the direction in which the socket housing 72 extends. The flange 74 has tapped holes 74a. The socket connector 70 is capable of being fastened to the surface of a housing (not illustrated), for example, by being screwed on the surface of the housing through these tapped holes 74a. An insertion space 78, into and from which part of the plug connector 20 is inserted and removed, is formed in the flange 74 and the wide portion 75. In the insertion space 78, two insertable portions 80, one on the left and the other on the right, are disposed so as to protrude toward the plug connector 20.

The plug connector 20 includes plug terminals 40 (see FIG. 2), an insulating plug housing 22, which supports the plug terminals 40, and a fastening portion 60, which fastens the plug terminals 40 to the plug housing 22. The plug housing 22 is a so-called right-angle connector, having a letter L shape in a side view. The plug housing 22 includes a body 23, which extends in the direction “b”, the same as the direction in which power source cables 3 extend, and an insertable portion 28, which extends toward the socket connector 70 in a direction perpendicular to the body 23 (extends in the direction of arrow “a” in the drawing).

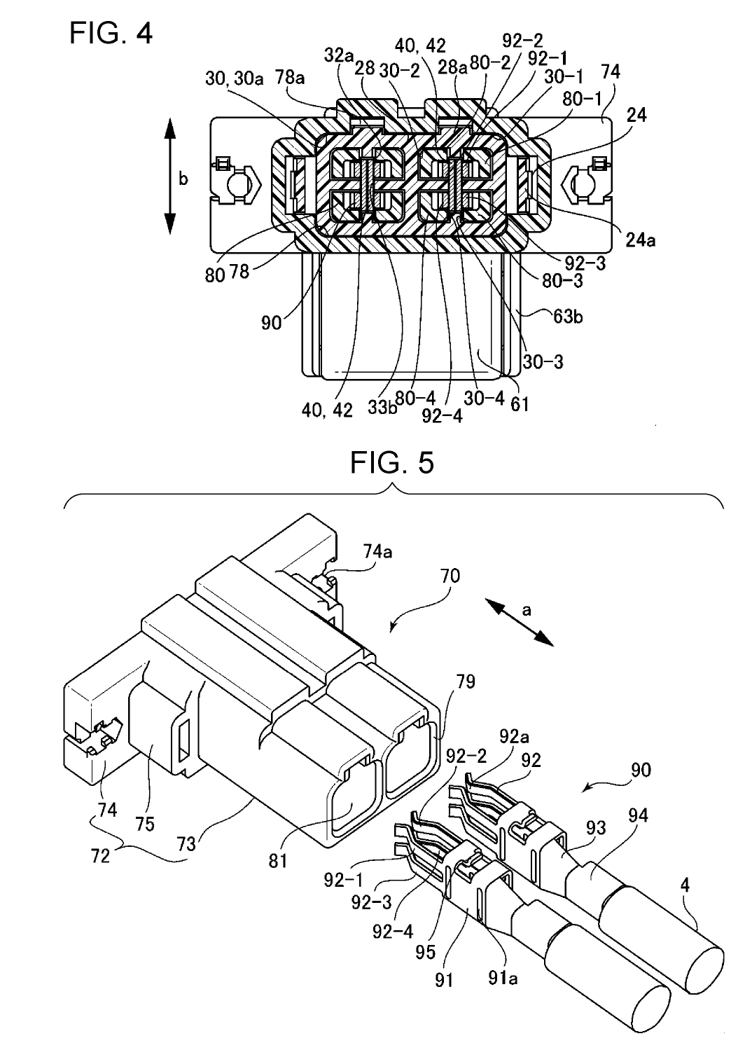

To fit the plug connector 20 and the socket connector 70 to each other, the insertable portion 28 of the plug connector 20 is inserted into the insertion space 78 of the socket connector 70 and the insertable portions 80 disposed in the insertion space 78 are inserted into a housing space 30 in the insertable portion 28. Thus, the socket terminals 90 of the socket connector 70 and the plug terminals 40 of the plug connector 20 can touch one another. FIG. 3 is a side view of the plug connector 20 and the socket connector 70 in the state of being fitted to each other and FIG. 4 is a sectional view of the plug connector 20 and the socket connector 70 taken along line IV-IV of FIG. 3.

Recessed portions 78a are disposed at upper portions of an insertion opening of the insertion space 78 of the socket connector 70. Corresponding to the recessed portions 78a, ridged portions 28a are disposed at upper portions of the insertable portion 28 of the plug connector 20. When the plug connector 20 and the socket connector 70 are to be fitted together, these recessed portions 78a and the ridged portions 28a are aligned to one another, so that the plug connector 20 can be easily guided to the socket connector 70 in a proper position.

On the left and right side surfaces of the insertable portion 28 of the plug connector 20, locking protrusions 24 supported by elastic arms 24a are disposed, the elastic arms 24a extending from the far end of the insertable portion 28 toward the fastening portion 60. When the plug connector 20 and the socket connector 70 are to be fitted to each other, the locking protrusions 24 are locked onto predetermined portions (not illustrated) of the socket connector 70 so that the plug connector 20 and the socket connector 70, which are fitted to each other, are locked together. This locking state of the plug connector 20 and the socket connector 70 can be freely canceled using lock control portions 25, disposed at end portions of the respective elastic arms 24a. Upper overhangs 23a and lower overhangs 23b, which restrict vertical movements of the respective lock control portions 25, are disposed to prevent the lock control portions 25 from being excessively shifted vertically.

FIG. 5 is an exploded perspective view of the socket connector 70. Two socket terminals 90, one on the left and the other on the right, each include a tubular base 91, each formed by being punched out from a sheet of metal and being bent, a crimped portion 94, disposed at the rear of the base 91 and crimped onto the cable 4, a connection portion 93, connecting the base 91 and the crimped portion 94 together, and elastic contact pieces 92, disposed at the far end portion of the base 91.

In the state where the power source cable 4 is fixed to the corresponding crimped portion 94, each socket terminal 90 is inserted into a corresponding insertion hole 81 of the socket housing 72 through an opening 79 disposed at a rear portion of the body 73. The base 91 of each socket terminal 90 preferably has protrusions 91a, which, when the socket terminal 90 is inserted into the corresponding insertion hole 81, come into contact with the inner wall of the socket housing 72 and prevent the socket terminal 90 from rattling. A portion 95 protruding upward beyond the upper surface of the base 91 is usable as a portion locked onto the socket housing 72 when each socket terminal 90 is inserted into the corresponding insertion hole 81.

The elastic contact pieces 92 are multiple, here, four separate terminal units 92-1 to 92-4. These terminal units 92-1 to 92-4 are connected together with the base 91 interposed therebetween. Thus, the terminal units 92-1 to 92-4 are integrally handleable here. At the far end of each of the terminal units 92-1 to 92-4, a contact point 92a, at which the terminal unit comes into contact with the corresponding plug terminal 40, is disposed.

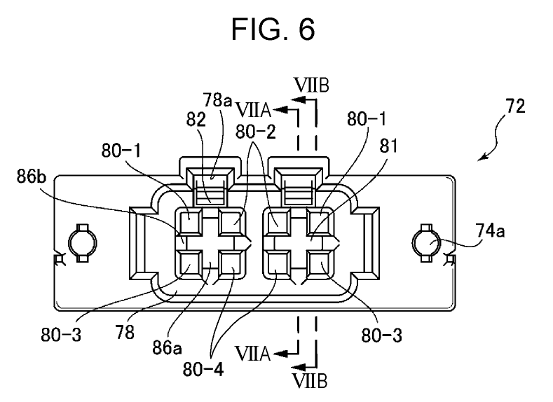

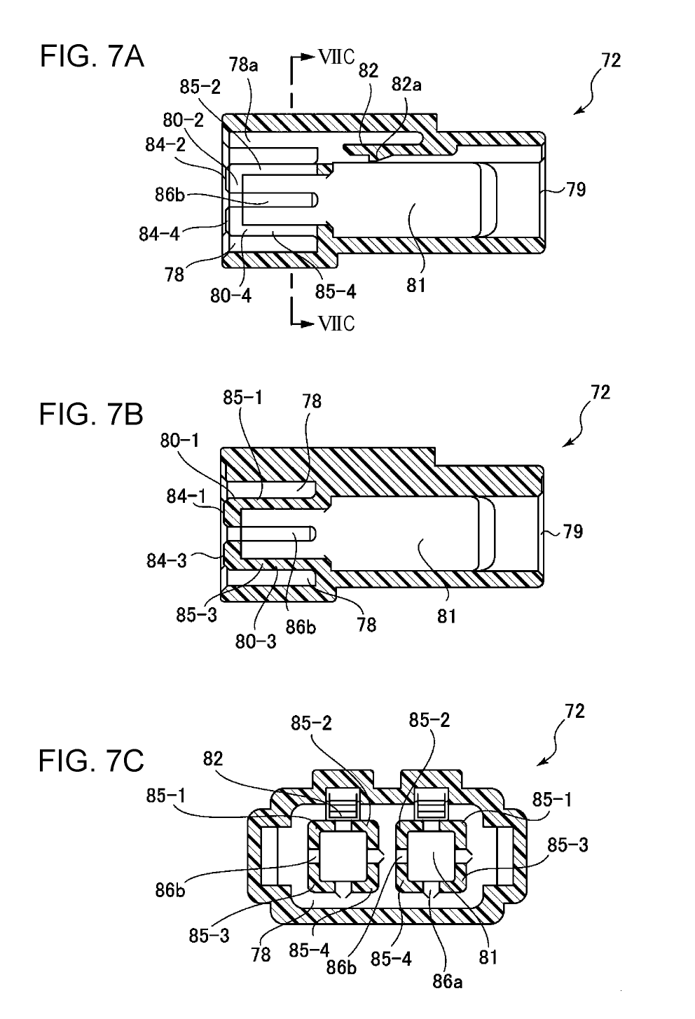

FIG. 6 is a front view of the socket housing 72, FIG. 7A is a sectional view of the socket housing 72 taken along line VIIA-VIIA of FIG. 6, FIG. 7B is a sectional view of the socket housing 72 taken along line VIIB-VIIB of FIG. 6, and FIG. 7C is a sectional view of the socket housing 72 taken along line VIIC-VIIC of FIG. 7A.

The two insertable portions 80, one on the left and the other on the right, are each divided into four smaller housed units (open ends) 80-1 to 80-4 so as to correspond to the terminal units 92-1 to 92-4 (see FIG. 5). Each insertable portion 80 has, for example, two cuts 86a and 86b, which cross each other, to be divided into the housed units 80-1 to 80-4. The cut 86a is a vertical cut and the cut 86b is a lateral cut. These housed units 80-1 to 80-4 respectively cover almost the entire surfaces of the terminal units 92-1 to 92-4 except the surfaces facing toward the center and used for contact with the corresponding plug terminal 40, in other words, except the surfaces opposing the other terminal units. More specifically, the terminal units 92-1 to 92-4 are respectively covered with front walls 84-1 to 84-4 of the housed units 80-1 to 80-4 at the surfaces (front surfaces) from which the terminal units are inserted into the plug connector 20 and covered with side peripheral walls 85-1 to 85-4 of the housed units 80-1 to 80-4 at two side peripheral surfaces. These front walls 84 and side peripheral walls 85 can prevent fingers from unintentionally touching the socket terminals 90 and can reduce problems such as a problem in which the terminal units 92-1 to 92-4 are buckled by mistake when the housed units 80-1 to 80-4 are inserted into and removed from the housing space 30.

A locking portion 82a, elastically movably supported by an elastic arm 82, is disposed inside each insertion hole 81 of the socket housing 72. When each socket terminal 90 is inserted into the corresponding insertion hole 81, the locking portion 82a is locked on and fixed to a locked portion 95 (see FIG. 5) disposed on the base 91 of the socket terminal 90.

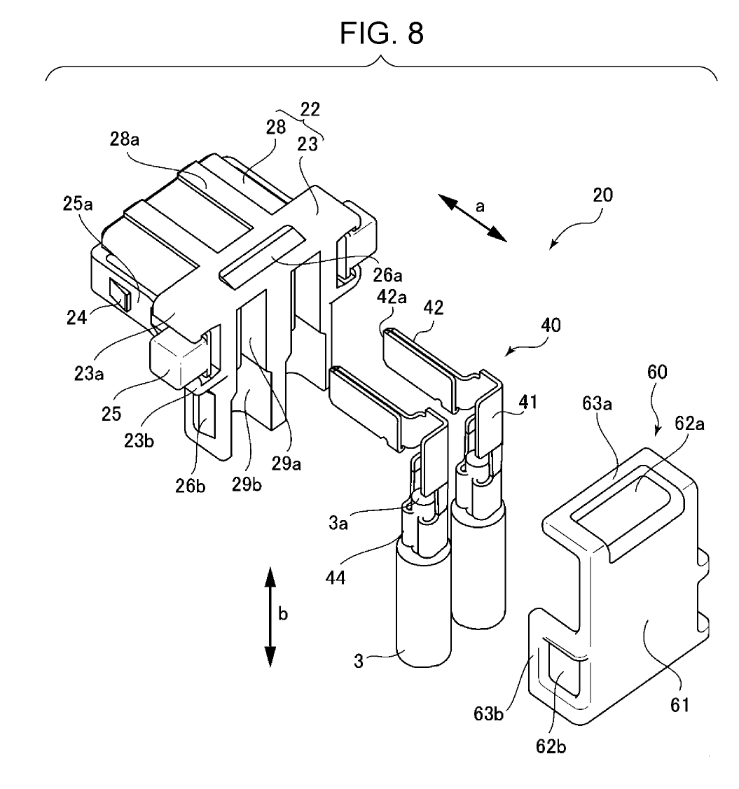

FIG. 8 is an exploded perspective view of the plug connector 20. Each plug terminal 40 includes a base 41, formed by being punched out from a sheet of metal and being bent, having a letter L shape when viewed in a plan, and extending vertically, a contact portion 42, extending horizontally from the base 41, and a crimped portion 44, extending downward from the base 41. The crimped portion 44 is crimped onto a conducting wire 3a disposed inside the corresponding power source cable 3. In the state where the crimped portion 44 fastens the power source cable 3, each plug terminal 40 is inserted into the plug housing 22 from the rear and installed therein. The fastening portion 60 is further fixed to the plug housing 22 at the rear of the plug housing 22.

Each contact portion 42 may be, for example, a flat contact piece. To secure the strength and to be resistant to high current, the contact portion 42 is formed by stacking two sheets of metal on top of the other. The contact portion 42 is disposed so as to extend vertically, that is, in the direction “b”, the same as the direction in which the body 23 of the plug housing 22 extends, and inserted into the plug housing 22 from the rear.

Recessed installation spaces 29 are disposed at rear portions of the body 23 of the plug housing 22. When each contact portion 42 is inserted into and installed in the plug housing 22, the base 41 is installed in an upper installation space 29a and the crimped portion 44 and a portion of the power source cable 3 are installed in a lower installation space 29b.

Lock protrusions 26a and 26b are respectively disposed on the top surface and the side surfaces of the body 23 of the plug housing 22. Corresponding to the lock protrusions 26a and 26b, a body 61 of the fastening portion 60 includes frame portions 63a and 63b, protruding toward the body 23 of the plug housing 22. The frame portions 63a and 63b respectively include lock holes 62a and 62b. When the lock protrusions 26a and 26b are respectively locked into these lock holes 62a and 62b, the fastening portion 60 can be fastened to the body 23 in the state where the plug terminals 40 are held in the plug housing 22.

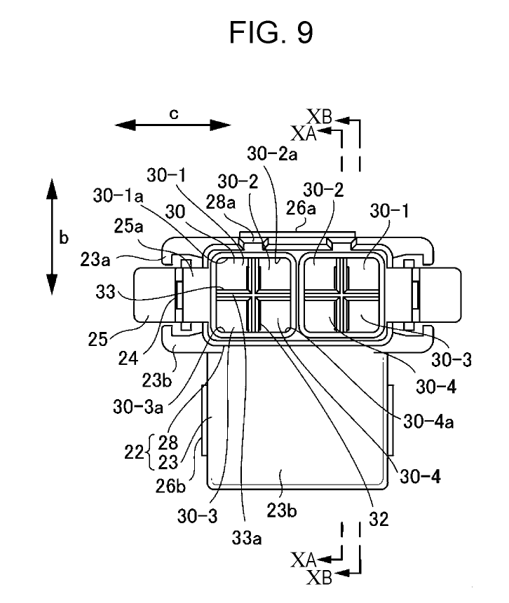

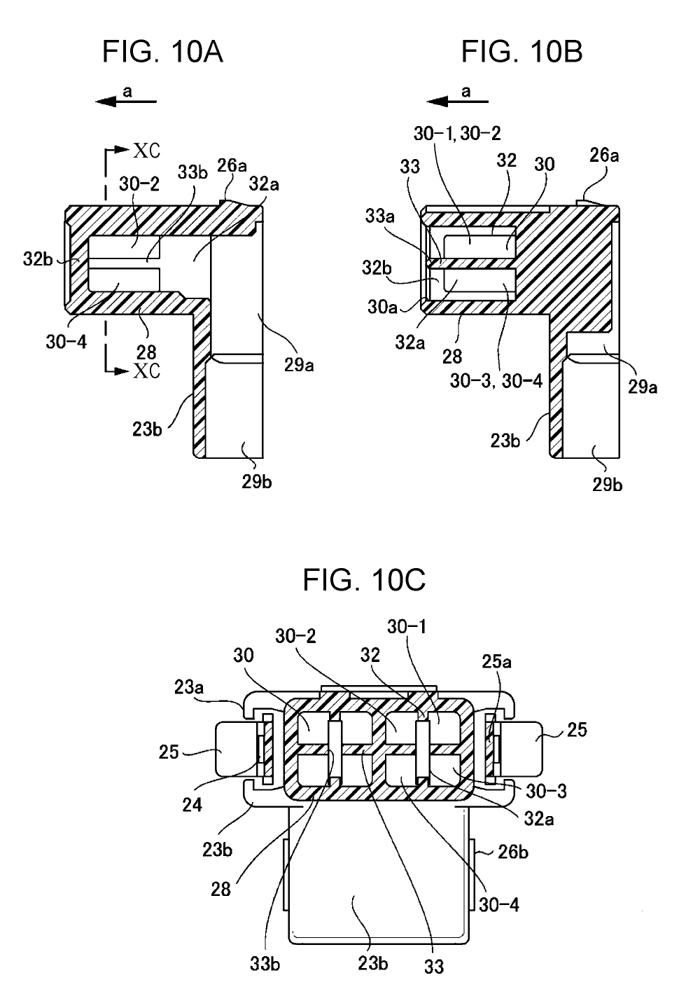

FIG. 9 is a front view of the plug housing 22. FIG. 10A is a sectional view of the plug housing 22 taken along line XA-XA of FIG. 9, FIG. 10B is a sectional view of the plug housing 22 taken along line XB-XB of FIG. 9, and FIG. 10C is a sectional view of the plug housing 22 taken along line XC-XC of FIG. 10A.

Two insertion ports 30a, one on the left and the other on the right, at the entrance of the housing space 30 in the insertable portion 28 of the plug housing 22 are each divided into four smaller insertion-port units 30-1a to 30-4a using two partitioning members 32 and 33, which cross each other. Each insertion port 30a is rendered smaller by being divided by these partitioning members 32 and 33. This configuration thus can effectively prevent an accident in which fingers touch the contact portions 42. More partitioning members may be provided to render each insertion port 30a much smaller.

The partitioning members 33 may be disposed in the horizontal direction, that is, a direction that crosses the contact portions 42, for example, in the direction of arrow “c” in FIG. 9 perpendicular to the contact portions 42. The partitioning members 33 may be formed from the plug housing 22. Use of the plug housing 22 can further reduce the cost than in the case of providing the partitioning members 33 as separate members. Disposing the partitioning members 33 can render each insertion port 30a smaller by partitioning adjacent insertion-port units 30-1a and 30-3a from each other and partitioning adjacent insertion-port units 30-2a and 30-4a from each other with the partitioning members 33 even when the contact portions 42 are large, specifically, as large as to extend across adjacent insertion ports, that is, across the insertion-port units 30-1a and 30-3a or across the insertion-port units 30-2a and 30-4a. Since the partitioning members 33 are formed from the insulating plug housings 22, fingers, if touch the partitioning members 33 including their far end portions 33a, would not receive an electric shock. This configuration thus can prevent accidents such as an electric-shock accident in which fingers touch the contact portions 42 of the plug terminals 40 by mistake. Preferably, the partitioning members 33 extend in the housing space 30 in the insertion direction “a” in which the socket terminals 90 are inserted thereinto through the insertion-port units 30-1a to 30-4a. Thus, the socket terminals 90 are insertable or removable in a more stable state. As described in this embodiment, preferably, the partitioning members 33 are connected, in the direction of arrow “c” in FIG. 9, to the inner walls defining the insertion ports 30a. This configuration can enhance the strength of the partitioning members 33.

The partitioning members 32 may be disposed in the vertical direction, that is, a direction that crosses the partitioning members 33, for example, in the direction “b”, the same as the direction in which the contact portions 42 extend. The partitioning members 32 may be formed from the plug housing 22. The partitioning members 32 may be constituted by only the plug housing 22. Alternatively, as in the case of this embodiment, each partitioning member 32 may be formed from a portion of the plug housing 22, for example, a substantially angular-C-shaped portion 32b at the entrance of the insertion port 30a and the contact portion 42 attached to the substantially angular-C-shaped portion 32b. Use of each contact portion 42 as part of the corresponding partitioning member 32 can further simplify the structure of the power-source connector than in the case where the contact portion 42 and the partitioning member 32 are separately provided. Each contact portion 42 may be disposed in, for example, a rectangular installation space 32a inside the substantially angular-C-shaped portion 32b (see FIGS. 10B and 10C) or may be inserted into an installation slot 33b formed in the partitioning member 33 (see FIGS. 10A and 10C). Each contact portion 42 can be aligned with the substantially angular-C-shaped portion 32b in the insertion direction “a” in which the socket terminal 90 is inserted through the insertion port 30a and thus can be stably disposed using the substantially angular-C-shaped portion 32b and the slot 33b. Here, each contact portion 42 is located on the side of the insertion port 30a opposite to the side from which the socket terminal 90 is inserted at a position further from the insertion port 30a than is at least part of the substantially angular-C-shaped portion 32b. This configuration can thus effectively prevent accidents such as an electric-shock accident in which fingers touch the contact portions 42 of the plug terminals 40 by mistake. Similarly to the partitioning members 33, each partitioning member 32 constituted by the substantially angular-C-shaped portion 32b and the contact portion 42 installed in the installation space 32a of the substantially angular-C-shaped portion 32b preferably extends in the housing space 30 in the insertion direction “a”, in which the socket terminal 90 is inserted through the insertion port 30a. Thus, the socket terminals 90 are insertable or removable in a more stable state. As described in this embodiment, the partitioning members 32 are preferably connected, in the direction of arrow “b” in FIG. 9, to the inner walls defining the insertion ports 30a. This configuration can enhance the strength of the partitioning members 32.

These partitioning members 32 and 33 define the housing units 30-1 to 30-4 in the housing space 30. Together with the terminal units 92-1 to 92-4 of each socket terminal 90, the housed units 80-1 to 80-4 of the socket housing 72 are respectively inserted into the housing units 30-1 to 30-4. Providing the housing units 30-1 to 30-4 allows the housed units 80-1 to 80-4 and the terminal units 92-1 to 92-4 to be more stably inserted into or removed from the housing space 30.

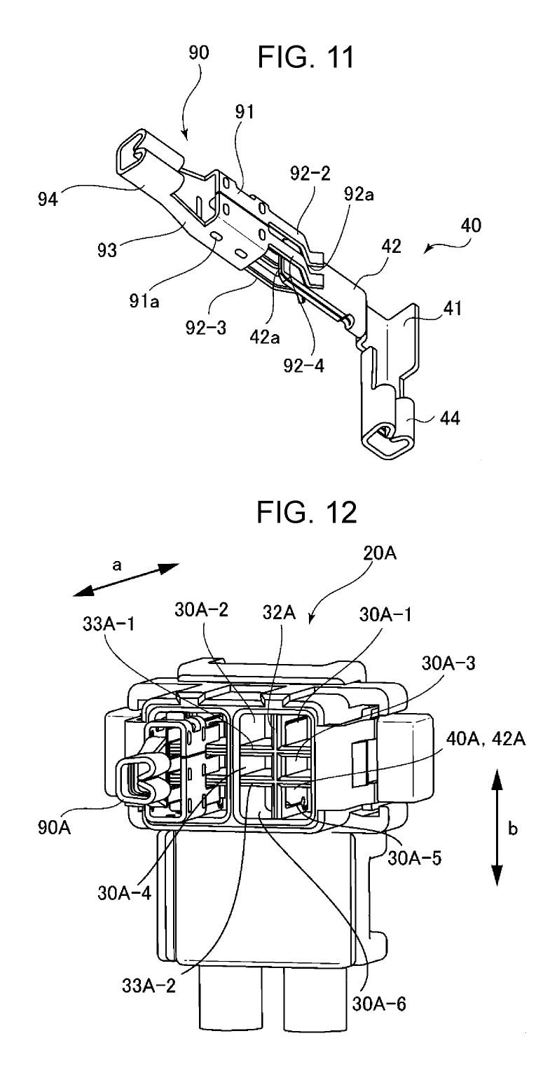

As illustrated in FIG. 4, when the plug connector 20 and the socket connector 70 are fitted to each other, the terminal units 92-1 to 92-4 of the socket connector 70 are respectively housed in the housing units 30-1 to 30-4 through the insertion-port units of the plug connector 20 together with the housed units 80-1 to 80-4 respectively covering at least part of the terminal units 92-1 to 92-4. FIG. 11 is a perspective view of the contact portion 42 of one plug terminal 40 and the terminal units 92-1 to 92-4 connected to one another when the plug connector 20 and the socket connector 70 are fitted together while components other than the terminals are excluded. As illustrated in FIG. 11, the contact portion 42 may be held by the terminal units 92-1 to 92-4. In this embodiment, one contact portion 42 is held between the terminal units 92-1 and 92-2 and between the terminal units 92-3 and 92-4. Causing each contact portion 42 to be held by the terminal units 92-1 to 92-4 enables more stable contact between the contact portion 42 and the terminal units 92-1 to 92-4. In addition, each socket terminal 90 comes into contact with the corresponding contact portion 42 at multiple points (four terminal units 92-1 to 92-4 in FIG. 11) to have a so-called multi-contact point structure. This structure does not cause defects such as generation of heat even under high current.

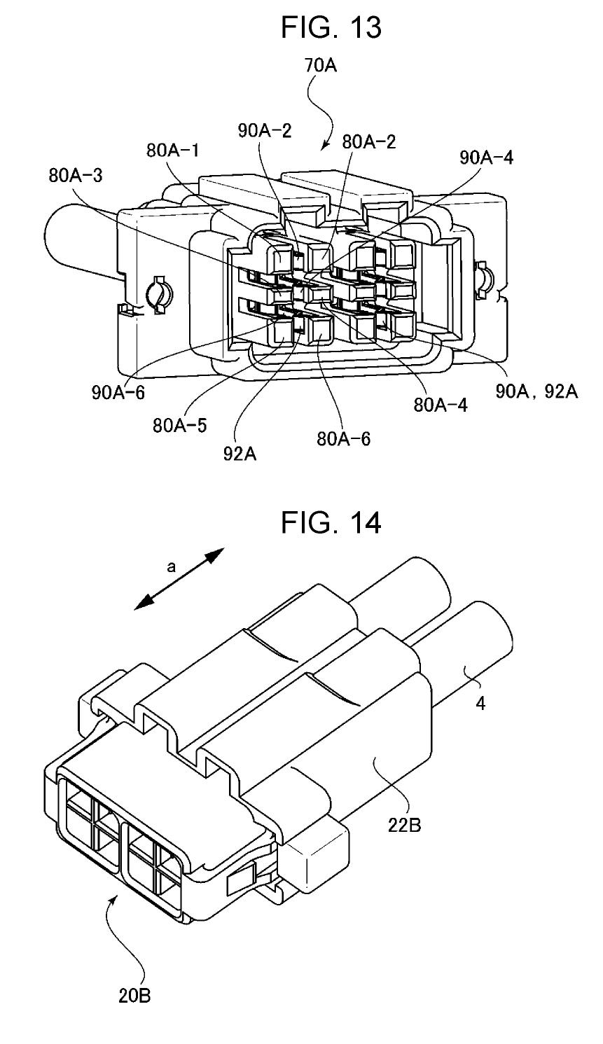

FIG. 12 and FIG. 13 illustrate a modified example obtained by modifying the embodiment illustrated in FIG. 1 to FIG. 11. FIG. 12 corresponds to FIG. 2, which illustrates the embodiment illustrated in FIG. 1 and other drawings, and is a schematic perspective view of only a plug connector 20A. FIG. 13 is a schematic perspective view of a socket connector 70A corresponding to the plug connector 20A illustrated in FIG. 12. The plug connector 20A according to the modified example includes a contact portion 42A, which is larger than the contact portion 42 according to the embodiment illustrated in FIG. 1 and other drawings. The plug connector 20A thus has vertical partitioning members 32A, which are larger than the vertical partitioning members 32. Here, the plug connector 20A includes two horizontal partitioning members 33A-1 and 33A-2, which cross one partitioning member 32A. Thus, in the modified example, six housing units 30A-1 to 30A-6 are provided on each of the left and right sides. Accordingly, the socket connector 70A includes, as illustrated in FIG. 13, six housed units 80A-1 to 80A-6 and six terminal units 90A-1 to 90A-6 on each of the left and right sides (for illustration convenience, only some of the units are illustrated).

FIG. 14 illustrates another modified example. FIG. 14 is a schematic perspective view of a socket 20B according to another modified example. Here, unlike the embodiment illustrated in FIG. 1 and other drawings, a plug housing 22B is a so-called straight connector, which extends straight when viewed sideways. Depending on the state of use, such as the shape of the housing or the installed position of the housing, a straight connector as illustrated in FIG. 14 is preferable rather than the right-angle connector illustrated in FIG. 1 and other drawings.

The description thus far has been given that, not only the socket terminals 90, but also the socket housing 72 is inserted into the insertion ports 30a or the housing space 30 of the plug connector 20. However, only the socket terminals 90 may be inserted thereinto without inserting the socket housing 72. Alternatively, not only the socket terminals 90, but also various types of electrically conductive members may be inserted into the housing space 30. Thus, the present invention is applicable to not only socket terminals but also various types of electrically conductive members including or not including socket housings.

The present invention can be formed by other different embodiments. Numerous details of the invention can be changed from various obvious points of view without departing from the spirit and the scope of the invention. The drawings and the description are thus mere examples and the invention is not limited to these.

What is claimed is:

1. A power-source connector, comprising:
a power-source terminal; and
a housing that supports the power-source terminal,
wherein the housing includes at least two adjoining insertion ports, each partitioned by a first partitioning member and through any of which an electrically conductive member is inserted, and a housing space, which is connected with the insertion ports,
wherein the power-source terminal includes a contact portion, disposed in the housing space and being contactable with the electrically conductive member inserted through any of the at least two adjoining insertion ports, and
wherein the contact portion is disposed so as to extend across the at least two adjoining insertion ports.

2. The power-source connector according to claim 1, wherein the first partitioning member extends in the housing space in a direction in which the electrically conductive member is inserted thereinto through any of the insertion ports.

3. The power-source connector according to claim 1, further comprising a second partitioning member that partitions each of the at least two adjoining insertion ports in a direction crossing the first partitioning member.

4. The power-source connector according to claim 3, wherein the first partitioning member and the second partitioning member are formed from the housing.

5. The power-source connector according to claim 3,
wherein the second partitioning member extends, together with the first partitioning member, in the housing space in an insertion direction in which the electrically conductive member is inserted thereinto through any of the insertion ports, and
wherein the first partitioning member and the second partitioning member define a plurality of housing units, housing a plurality of pieces of the electrically conductive member.

6. The power-source connector according to claim 5, wherein the plurality of pieces of the electrically conductive member are at least partially covered with housed units corresponding to the pieces of the electrically conductive member and are housed in the respective housing units together with the corresponding housed units.

7. The power-source connector according to claim 5, wherein the plurality of pieces of the electrically conductive member are connected to one another.

8. The power-source connector according to claim 5, wherein the contact portion constitutes a portion of the second partitioning member.

9. The power-source connector according to claim 8, wherein the contact portion is located on a side of the insertion ports opposite to a side from which the electrically conductive member is inserted at a position further from the insertion ports than is a portion of the second partitioning member.

10. The power-source connector according to claim 8, wherein the contact portion is held by the electrically conductive member inserted into the housing units.

11. A power-source connector device, comprising:
the power-source connector according to claim 6; and
a different power-source connector that supports the electrically conductive member,
wherein the plurality of housed units are constituted by a housing of the different power-source connector, and the plurality of pieces of the electrically conductive member are supported by the housing.
